(19) United States
(12) Patent Application Publication
(10) Pub. No.: US 2024/0196029 A1
(43) Pub. Date: Jun. 13, 2024

(54) TEMPORAL ANALYSIS TO DETERMINE SHORT-FORM VIDEO ENGAGEMENT

(71) Applicant: Loop Now Technologies, Inc., San Mateo, CA (US)

(72) Inventor: Vishal Arora, Walnut Creek, CA (US)

(73) Assignee: Loop Now Technologies, Inc., San Mateo, CA (US)

(21) Appl. No.: 18/534,784

(22) Filed: Dec. 11, 2023

Related U.S. Application Data
(60) Provisional application No. 63/546,768, filed on Nov. 1, 2023.
(60) Provisional application No. 63/546,077, filed on Oct. 27, 2023.
(60) Provisional application No. 63/536,245, filed on Sep. 1, 2023.
(60) Provisional application No. 63/524,900, filed on Jul. 4, 2023.
(60) Provisional application No. 63/522,205, filed on Jun. 21, 2023.
(60) Provisional application No. 63/472,552, filed on Jun. 12, 2023.
(60) Provisional application No. 63/464,207, filed on May 5, 2023.
(60) Provisional application No. 63/458,733, filed on Apr. 12, 2023.
(60) Provisional application No. 63/458,458, filed on Apr. 11, 2023.
(60) Provisional application No. 63/458,178, filed on Apr. 10, 2023.
(60) Provisional application No. 63/454,976, filed on Mar. 28, 2023.
(60) Provisional application No. 63/447,918, filed on Feb. 24, 2023.
(60) Provisional application No. 63/447,925, filed on Feb. 24, 2023.
(60) Provisional application No. 63/443,063, filed on Feb. 3, 2023.
(60) Provisional application No. 63/438,011, filed on Jan. 10, 2023.
(60) Provisional application No. 63/437,397, filed on Jan. 6, 2023.
(60) Provisional application No. 63/431,757, filed on Dec. 12, 2022.
(60) Provisional application No. 63/604,261, filed on Nov. 30, 2023.

(51) Int. Cl. H04N 21/254; G06Q 30/0207; G06Q 30/08; H04N 21/475; H04N 21/478

(52) U.S. Cl. CPC H04N 21/2542; G06Q 30/0239; G06Q 30/08; H04N 21/4758; H04N 21/47815

(57) ABSTRACT

Disclosed embodiments provide techniques for temporal analysis to determine short-form video engagement. One or more processors are used to insert a container unit into a webpage. The container unit is populated with one or more short-form videos selected from a video library. The selected short-form videos are presented to a user. User interactions with the short-form videos, including polls, text responses, and purchase history, are evaluated and associated with the videos. The user interactions are evaluated while the user is watching and interacting with the videos. An engagement metric is calculated, based on comparing a first rate of change in the user interactions with the short-form videos to a second rate of change in the user interactions. The resulting engagement metric is recorded and associated with the video. Ecommerce purchases of products featured in the videos are enabled, including a virtual purchase cart.

### RELATED APPLICATIONS

This application claims the benefit of U.S. provisional patent applications “Temporal Analysis To Determine Short-Form Video Engagement” Ser. No. 63/431,757, filed Dec. 12, 2022, “Connected Television Livestream-To-Mobile Device Handoff In An Ecommerce Environment” Ser. No. 63/437,397, filed Jan. 6, 2023, “Augmented Performance Replacement In A Short-Form Video” Ser. No. 63/438,011, filed Jan. 10, 2023, “Livestream With Synthetic Scene Insertion” Ser. No. 63/443,063, filed Feb. 3, 2023, “Dynamic Synthetic Video Chat Agent Replacement” Ser. No. 63/447,918, filed Feb. 24, 2023, “Synthesized Realistic Metahuman Short-Form Video” Ser. No. 63/447,925, filed Feb. 24, 2023, “Synthesized Responses To Predictive Livestream Questions” Ser. No. 63/454,976, filed Mar. 28, 2023, “Scaling Ecommerce With Short-Form Video” Ser. No. 63/458,178, filed Apr. 10, 2023, “Iterative AI Prompt Optimization For Video Generation” Ser. No. 63/458,458, filed Apr. 11, 2023, “Dynamic Short-Form Video Transversal With Machine Learning In An Ecommerce Environment” Ser. No. 63/458,733, filed Apr. 12, 2023, “Immediate Livestreams In A Short-Form Video Ecommerce Environment” Ser. No. 63/464,207, filed May 5, 2023, “Video Chat Initiation Based On Machine Learning” Ser. No. 63/472,552, filed Jun. 12, 2023, “Expandable Video Loop With Replacement Audio” Ser. No. 63/522,205, filed Jun. 21, 2023, “Text-Driven Video Editing With Machine Learning” Ser. No. 63/524,900, filed Jul. 4, 2023, “Livestream With Large Language Model Assist” Ser. No. 63/536,245, filed Sep. 1, 2023, “Non-Invasive Collaborative Browsing” Ser. No. 63/546,077, filed Oct. 27, 2023, “AI-Driven Suggestions For Interactions With A User” Ser. No. 63/546,768, filed Nov. 1, 2023, and “Customized Video Playlist With Machine Learning” Ser. No. 63/604,261, filed Nov. 30, 2023.

Each of the foregoing applications is hereby incorporated by reference in its entirety.

### FIELD OF ART

This application relates generally to short-form videos and more particularly to temporal analysis to determine short-form video engagement.

### BACKGROUND

The combination of sight and sound have been a part of our understanding and appreciation of the world around us from the beginning. For many of us, our earliest memories are made of familiar faces and voices, places and songs, family members, pets, children shouting or laughing, etc. Our art forms are often made up of visual and audible forms of stimulus—painting, sculpture, weaving, instrumental and vocal music, photography, plays, and so on. Over time, music has become more varied and elaborate, with influences from many other cultures and eras. Visual arts have expanded in the use of color and pattern. Artists often combine visual pieces with music, spoken words, or other recorded sounds. Motion pictures, television, and videos have become important avenues that we use to express ourselves, inform, instruct, entertain, persuade, buy, and sell. Professionals and amateurs now produce motion pictures and videos at a phenomenal rate and in increasingly sophisticated ways. Computers can be used to draw images with colors and textures simultaneously. Motion pictures are made using both film and digital recording. Animation has grown from single-pane cartoons to three-dimensional images which are nearly indistinguishable from real life. Pieces of art that were once available only in a museum can now be viewed anywhere at any time. Their images can be manipulated using software available on a home computer or cell phone. Photographs and videos can be quickly taken and edited on handheld devices and distributed via social media platforms within minutes of being produced.

As the various forms of producing and refining informational and artistic content have grown, so have methods to preserve, store, and categorize the content for future study as well as immediate use. Larger and more efficient methods of data storage and retrieval have grown exponentially over the past few years, accelerated by the recent COVID-19 pandemic and the demand to move large amounts of information efficiently to more and more user endpoints. Vast networks of storage devices and increasingly powerful systems to manage and maintain data have grown across nations and continents in order to satisfy requirements of governments, multi-national conglomerates, and everyday individual users. Individuals shoot videos using cell phones or tablets for all sorts of reasons: to remember a special event or place, to demonstrate the latest dance craze, to play songs or recite poetry, to teach, to share, to laugh, or to grieve. Billions of people actively use social media and routinely include digital pictures and recorded videos in everyday communication. In social media systems and other content sharing systems, video, music, and other media files are encoded and transmitted in sequential packets of data so they can be streamed instantaneously. Photos, sound bites, and short-form videos produced worldwide expand our perception immeasurably. Our continued desire to link sight and sound in ways that can excite, inform, persuade, entertain, and communicate more effectively has not abated since humanity began, and it shows no sign of slowing in our future.

### SUMMARY

Techniques for evaluating videos are disclosed. The use of short-form videos continues to expand as multiple methods for producing and editing video content are being made available. A user preference for video content in searches, product evaluation, education, and sales has grown steadily over the past several years and will continue to expand. Methods for evaluating short-form videos and associating the results of evaluations to the videos can provide ways for advertisers, vendors, educators, and others to classify the growing number of videos and select the most effective items for use in specific applications.

Disclosed embodiments provide techniques for temporal analysis to determine short-form video engagement. One or more processors are used to insert a container unit into a webpage. The container unit is populated with one or more short-form videos selected from a video library. The selected short-form videos are presented to a user. User interactions with the short-form videos, including polls, text responses, and purchase history, are evaluated and associated with the videos. The user interactions are evaluated while the user is watching and interacting with the videos. An engagement metric is calculated, based on comparing a first rate of change in the user interactions with the short-form videos to a second rate of change in the user interactions. The resulting engagement metric is recorded and associated with the video. Ecommerce purchases of products featured in the videos are enabled, including a virtual purchase cart.

A computer-implemented method for evaluating videos is disclosed comprising: inserting a container unit into a webpage; populating the container unit with one or more short-form videos from a short-form video library; rendering a short-form video from within the one or more short-form videos to a user, wherein user interactions are associated with the short-form video; evaluating the user interactions, using one or more processors, wherein the evaluating occurs as the video is rendered to the user; calculating an engagement metric, wherein a first rate of change in the user interactions during a first time period is compared to a second rate of change in the user interactions over a second time period; and recording the engagement metric, wherein the engagement metric is associated with the short-form video. In embodiments, the populating the container unit is based on the engagement metric that was recorded with the one or more short-form videos. Some embodiments comprise changing an order of the one or more short-form videos in the container unit based on the engagement metric recorded with the one or more short-form videos. In embodiments, the changing the order is based on the engagement metric of a neighboring short-form video.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for temporal analysis to determine short-form video engagement.

FIG. 2 is a flow diagram for enabling temporal analysis to determine short-form video engagement.

FIG. 3 is an infographic for temporal analysis to determine short-form video engagement.

FIG. 4 is an infographic for moving a short-form video based on an engagement metric.

FIG. 5 is an infographic for removing a short-form video based on an engagement metric.

FIG. 6 is an infographic for boosting an engagement metric.

FIG. 7 shows populating of a container unit.

FIG. 8 shows an ecommerce purchase with a container unit.

FIG. 9 is a system diagram for stochastic data to determine short-form video engagement.

### DETAILED DESCRIPTION

Short-form videos are used by governments, companies, influencers, consumers, and casual users across the globe to create, gather, and distribute information about products and services. Our society is becoming more mobile and more electronically connected, requiring vendors, advertisers, and those who desire to influence others with regard to products and services to use multi-media methods more effectively. Companies and individuals produce short-form videos using multiple formats and approaches, demonstrating the use of products and related services, comparing their products to competitors, etc. In some cases, endorsements by celebrities and known experts are included, as well as instructional videos detailing the uses of products in particular applications. Once created, these digital videos can be edited rapidly and distributed even more quickly. Using various social media platforms, consumers can comment on their experiences with products and companies and share them with others. These comments often take the form of short-form videos as well, greatly expanding the number of videos available to help sell goods and services. The opportunity to purchase products online can be provided electronically using virtual product carts, in many cases on the same platform on which the short-form videos are presented. Purchases without any in-person interactions with sales representatives or products have become commonplace. Instead, customers routinely make purchase decisions based on information gathered electronically through social media outlets or vendor websites. However, the effectiveness of short-form videos varies substantially. Regardless of the source, professional or amateur, some short-form videos work more effectively than others to inform, persuade, educate, or sell products and services. As the number of short-form videos being produced continues to rise, a standardized method of measuring and recording the effectiveness of the videos can be extremely valuable in selecting and developing the most useful videos for various purposes. The ability to collect, refine, and record a standard measurement as users view the short-form videos can be vital as the pace of product development and short-form video production continues to expand.

Techniques for evaluating short-form videos are disclosed. A search for products, services, or related information can be generated by a user on a webpage. The search can be captured by one or more processors and can be used to select a set of short-form videos from a library of videos. As the videos are selected, a container unit can be inserted into the user webpage and populated with short-form videos that meet the search criteria. The arrangement of short-form videos within the container unit can vary depending on the number of videos, the size of the display, and so on. As the user begins to view the selected short-form videos, polls, questions, or texts related to the videos can be displayed to elicit a user's response. As the user responds, metadata regarding the user, as well as the video on display, can also be collected and used along with the user interactions to calculate an engagement metric. The engagement metric uses stochastic analysis techniques to determine a score indicating the user level of interest and interaction with the short-form video being viewed. As the video plays, multiple calculations of the engagement metric can be taken and compared. The engagement metric can also be recorded to the metadata of the short-form video for future reference and refinement as multiple users view the same video in different searches. The short-form videos in the container unit can be sorted as the videos receive an engagement score so that the best scoring videos appear first. In some embodiments, a threshold value can be established so that videos with engagement scores that fall below the threshold can be removed from the container unit and replaced with others. In some embodiments, a vendor or advertiser can bid to have their short-form video engagement metric score boosted by normalizing their score with other videos appearing in the same container unit. As the short-form videos in the library continue to be viewed and their engagement metrics calculated and refined, the most effective videos move to the front of the container units more and more often.

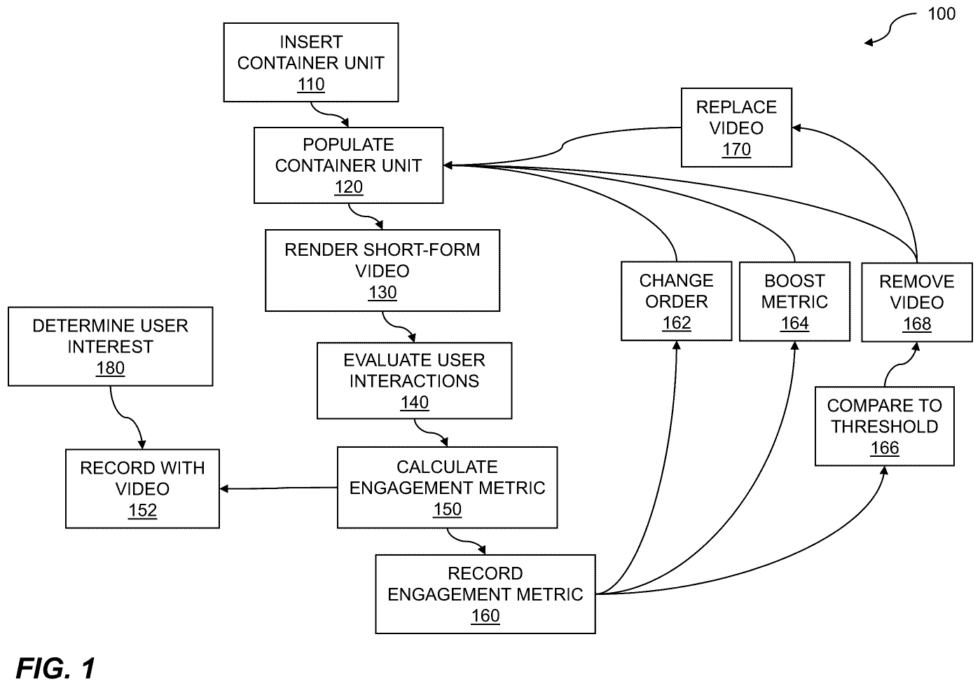

FIG. 1 is a flow diagram 100 for temporal analysis to determine short-form video engagement. A search for products, services or related information can be generated by a user on a webpage. The search can be used to select a set of short-form videos from a video library. A container unit can be inserted into the webpage that created the search and the selected short-form videos can be used to populate the container unit. As the videos begin to play for the user, questions, polls, or texts can be rendered to the user and responses from the user can be collected and evaluated. Metadata regarding the user as well as metadata about the short-form video can be combined with the user responses to calculate an engagement metric. The engagement metric is a measurement of user interest and interaction with the short-form video. It can be taken at multiple points during the viewing of the short-form videos in the container unit and recorded into the metadata of each short-form video. The engagement metric can be used to sort the short-form videos in the container unit so that the highest scoring video appears in the first position. A threshold value can be established to remove videos that elicit an engagement metric that is below the threshold. Advertisers can bid to boost their short-form video engagement score by normalizing it with other videos appearing in the container unit.

The flow 100 can include inserting a container unit 110 into a webpage. In embodiments, a user webpage can initiate a search for videos, for one or more items for sale, or for other subjects of interest. The search request can be captured by one or more processors and can be used to start a search for related short-form videos from a short-form video library. As the selection of short-form videos progresses, a container unit 110 can be inserted into the user webpage. In some embodiments, the container unit comprises a carousel frame widget, a story block frame widget, a grid frame widget, or a floating video player widget. A carousel frame widget inserts a set of related containers within a primary container, each populated by a single related short-form video. A carousel frame widget allows multiple selected videos to be placed on the website simultaneously. Story blocks are stock-published video footage, templates, music, and photo content available for download from vendors. A story block frame widget populates a container with one or more story block videos from a particular vendor. A grid frame widget allows elements to be placed in specific locations within the container using standardized row and column references. Header information, color schemes, company logos, etc., can thus be placed into the container unit in specific locations along with the selected short-form videos. A floating video player widget is a video player program that runs entirely within the container unit without affecting the displayed main webpage. The container unit “floats” on top of the originating website page so that no format or content disruption occurs.

The flow 100 can include populating the container unit 120 with at least one selected short-form video. In embodiments, the selected videos can include organic, sponsored, or promotional short-form videos. Organic videos are made by users and shared using the free, built-in capabilities of a particular social media platform. Every social media platform has capabilities available to any user: posts, hashtags, likes, shares, etc. Videos shared with these built-in capabilities are part of the natural uses of the platform itself. Sponsored videos are paid for and directly associated with a particular organization, group, or individual. Promoted videos are presented to viewers by third parties, celebrities, social media influencers, advertisers, product manufacturers, etc. They can be recommended to viewers as part of other forms of advertising or within other forms of media. In some embodiments, the short-form videos comprise a livestream video or livestream video replay. Livestream events are broadcast over the Internet for live viewing. These events are typically recorded for rebroadcast as stand-alone videos in complete or edited form. In some embodiments, populating the container unit 120 can be based on a bid from an advertiser. There are several models for advertising bids on short-form videos. In some embodiments, advertisers are charged once fifty percent of their short-form videos are viewed for at least six seconds. Other models charge the advertiser after the first frame of the video is viewed. Others charge the advertiser only after the entire video has been viewed for at least three seconds. Regardless of the specific bidding model used, in embodiments, the more an advertiser pays per view, the higher the short-form video is ranked in the populating process.

The flow 100 can include rendering the selected short-form video 130 to a user, wherein user interactions are associated with the short-form video. In embodiments, the user webpage can be viewed on a personal computer, a laptop computer, a mobile device, a tablet, or a pad. As the short-form video is played within the inserted container unit 110, user interactions with the video can be elicited and captured for evaluation 140. In some embodiments, the user interactions can include polls taken by the user while viewing the video, questions answered by the user while viewing the video, or text responses from the user while viewing the video. A purchase history by the user can also be included, as well as video consumption data from third-party sources. In embodiments, the rendering includes a second short-form video. As with the first short-form video, user interactions with the second video can be monitored and evaluated 140.

The flow 100 can include calculating an engagement metric 150 for the one or more short-form videos, based on the user interaction evaluations 140. In embodiments, a first rate of change in the user interactions during a first time period can be compared to a second rate of change in the user interactions over a second time period. The change in content engagement with the video between the first and second time periods can be used to determine an increase or decrease in engagement, thus generating a metric for the short-form video content. For example, as a user begins to watch a short-form video and respond to related questions that appear on the screen, the response time to questions during the first 20 seconds of the video may be short, indicating high interest and engagement with the video. After 45 seconds, the response time to questions may increase, indicating a loss of interest. After 60 seconds, user responses may cease altogether. The resulting engagement metric for such an example would be lower than for a video that elicited short response times to questions for the duration of the video. As the user views a short-form video, user interest in the video can be determined 180, based on a view history by the user, wherein the view history includes a total watch time. In some embodiments, the total watch time can include view history from a plurality of users. The user interest metric can be recorded 152 with the short-form video as part of the video metadata and used in the calculation of the engagement metric. The calculated engagement metric 150 can be recorded 160 with the short-form video as part of the video metadata.

Note that there are always only two time periods being compared: the first time period and the second time period. However, in order to distinguish various comparisons from each other, a second occurrence of a comparison between the first time period and the second time period may be referred to as comparing a “third” time period and a “fourth” time period. Similarly, a third occurrence of a comparison between the first time period and the second period may be referred to as comparing the “fifth” time period and the “sixth” time period, and so on. Specifically, the first instance of comparing may involve comparing an engagement metric rate of change and may be designated as comparing a first time period and a second time period; the second instance of comparing may involve comparing a metadata rate of change and may be designated as comparing a third time period and a fourth time period; the third instance of comparing may involve comparing a combined metric rate of change and may be designated as comparing a fifth time period and a sixth time period. Thus some embodiments comprise calculating a second engagement metric, wherein a first rate of change of the metadata during a third time period is compared to a second rate of change in the metadata over a fourth time period. And some embodiments comprise determining a combined metric based on combining the metadata and the user interactions, wherein the combined metric is based on a first rate of change of the combined metric over a fifth time period compared to a second rate of change of the combined metric over a sixth time period. And some embodiments comprise determining user interest, based on a view history by the user, wherein the view history includes a total watch time, wherein the user interest is based on a first rate of change of the view history over a seventh time period compared to a second rate of change in the view history over an eighth time period. In general, the second of the two time periods can be considered to occur subsequent to the first of the two time periods. The elapsed time between time periods can vary, such as seconds, minutes, hours, or even days or weeks.

In some embodiments, the engagement metric calculation can include temporal analysis. Temporal analysis is a statistical methodology for examining and modeling the behavior of a variable within a set of data over time, specifically to determine whether and how concentrations are changing over time. There are several analysis techniques that can be used for this purpose, including time series plots, one-way Analysis of Variance (ANOVA), sample autocorrelation, rank von Neumann tests, seasonal correlations, etc. In embodiments, temporal analysis can be used to study the change in engagement of a user with one or more short-form videos to determine whether interest in a particular video or set of videos changes over time and if so, to what extent. In some embodiments, the engagement metric calculation can include stochastic analysis techniques. The engagement metric is a probabilistic rather than deterministic model. This means that there is a random element to be considered in the calculation and use of the engagement metric. Stochastic process mathematics can be used to take a family of random variables into account when calculating the engagement metric. There are several different stochastic techniques that can be used in such analyses such as random walks, Markov, Levy, Gaussian, renewal, branching processes, etc. As use of the engagement metric progresses, stochastic analysis methods can be used to refine the calculation and utility of the metric.

The flow 100 can include a threshold engagement metric that can be compared 166 to the recorded engagement metric assigned to the short-form video viewed by the webpage user. In some embodiments, a short-form video that has an engagement metric lower than the threshold can be removed 168 from the list of one or more short-form videos used to populate the container unit 120, and a different video from the library can be used to replace it 170. As the webpage user views multiple short-form videos populating the container unit 120, engagement metrics can be assigned to each video as a result of user interactions being evaluated 140. The calculated engagement metric 150 can be recorded into the metadata of the short-form videos and can then be compared to each other. In some embodiments, the order of the short-form videos in the container unit can be changed 162 so that the video with the highest engagement metric appears in the first position, the second highest engagement metric appears in the second position, and so on. In some embodiments, the engagement metric can be boosted 164 in order to reflect the impact of neighboring short-form videos in the same container. The opportunity to boost the engagement metric can be auctioned to advertisers so that their short-form videos receive more views and avoid being dropped from subsequent video searches. For example, if the second short-form video in a container has an engagement metric of 6, the third short-form video has an engagement metric of 4, and the fourth short-form video has an engagement metric of 7, an advertiser linked to the third short-form video could bid to have its engagement metric boosted. One method of boosting the engagement metric would be to calculate a normalized metric by adding the values of the second and fourth short-form videos together and then subtracting the original engagement metric (6+7−4=9). The boosted engagement metric value 9 would then be recorded into the metadata of the third video and the order of the videos in the container would be changed to reflect the boosted metric. Various steps in the flow 100 may be changed in order, repeated, omitted, or the like without departing from the disclosed concepts. Various embodiments of the flow 100 can be included in a computer program product embodied in a non-transitory computer-readable medium that includes code executable by one or more processors.

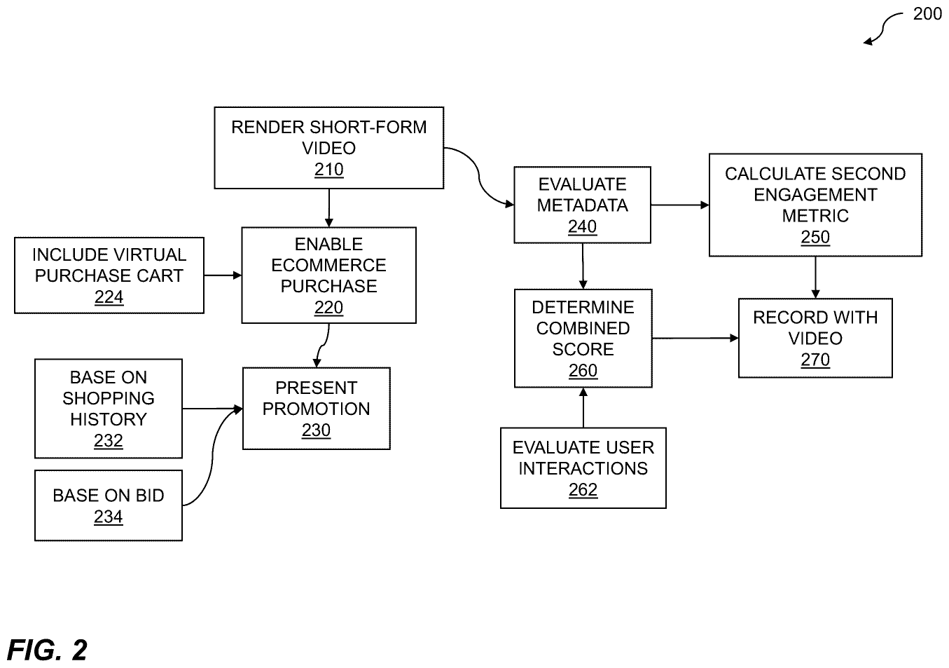

FIG. 2 is a flow diagram for enabling temporal analysis to determine short-form video engagement. Temporal analysis is a statistical methodology for examining and modeling the behavior of a variable within a set of data over time, specifically to determine whether and how concentrations are changing over time. There are several analysis techniques that can be used for this purpose, including time series plots, one-way ANOVA, sample autocorrelation, rank von Neumann tests, seasonal correlations, etc. In embodiments, temporal analysis can be used to study the change in engagement of a user with one or more short-form videos to determine whether interest in a particular video or set of videos changes over time and to what extent.

Stochastic analysis can also be used to calculate the engagement metric. In embodiments, the engagement metric is a probabilistic rather than deterministic model. This means that there is a random element to be considered in the calculation and use of the engagement metric. Stochastic process mathematics can be used to take a family of random variables into account when calculating the engagement metric. There are several different stochastic techniques that can be used in such analyses, such as random walks, Markov, Levy, Gaussian, renewal, branching processes, etc. As use of the engagement metric progresses, some embodiments can be used to refine the calculation and utility of the metric using stochastic analysis.

The flow 200 includes rendering one or more short-form videos 210 to a user on a website. In embodiments, a user search for short-form videos, information on products for sale, etc., can be captured by one or more processors and used to search for short-form videos from a video library. A container unit can be inserted into the user website and one or more short-form videos can be used to populate the container unit. The container unit can be arranged in different configurations using various widgets. The configuration can include a carousel, story block, grid, or floating player frame arrangement. In some embodiments, as the user views the short-form videos, interaction with the video is encouraged and measured using polls, questions, or texts. The user responses, and the rate at which the responses occur is measured and used to calculate an engagement metric. The calculated engagement metric is recorded into the metadata of the short-form video.

The flow 200 can include evaluating the metadata 240 of short-form videos rendered 210 to the website user. In embodiments, the metadata can include hashtags, repost velocity, user attributes, user history, ranking, product purchase history, view history, and user actions. In some embodiments, the engagement metric calculated by evaluating user interactions 262 with a short-form video can be combined with metadata values to determine a combined score 260. The combined score can be recorded into the metadata of the short-form video 270. A second engagement metric can also be calculated 250 based on repeated rate-of-change measurements as a short-form video continues to be played in a container unit. The updated engagement metric can be recorded in the metadata of the short-form video and used with the first user or other users in additional container sets. Thus, the engagement metric of each short-form video continues to be adjusted and refined as a user interacts with it, and as other users view the same short-form videos and contribute to the combined score. In embodiments, the combined metric is based on a first rate of change of the combined metric over a fifth time period compared to a second rate of change of the combined metric over a sixth time period.

The flow 200 can include enabling ecommerce purchases 220 of products or services for sale that are highlighted in short-form videos rendered to the website user. In embodiments, a virtual purchase cart 224 can be included in the container unit inserted into the webpage. A virtual purchase cart is a web-based software application that allows a user to select products and services for sale on various websites or appearing in videos to be added to a list and ultimately purchased using financial options such as credit cards, online bank accounts, etc. In some embodiments, the virtual purchase cart can be displayed while the short-form video plays. It can overlay a portion of the related short-form video or appear on one side of the video container. It can collect items selected for purchase from a list to be displayed and confirmed at a later time. In some embodiments, promotions from a vendor or advertiser can be presented 230 to the website user as items for sale are selected. The promotions can be based on the shopping history of the user 232 or on bids 234 submitted by the advertiser or vendor of the products. When the user is ready to complete the purchase process, the purchase cart can be expanded to display the virtual cart contents. The user can alter the quantities of items in the cart or remove them as desired. The user can check out, completing the purchase process. The decision to purchase products rendered for viewing can be recorded and added to the metadata of the short-form video or group of videos being reviewed by the user. Thus, the rendering and engagement of users of short-form videos with ecommerce options included can enhance the sales opportunities of vendors and advertisers and provide insight into producing more effective videos.

Various steps in the flow 200 may be changed in order, repeated, omitted, or the like without departing from the disclosed concepts. Various embodiments of the flow 200 can be included in a computer program product embodied in a non-transitory computer-readable medium that includes code executable by one or more processors.

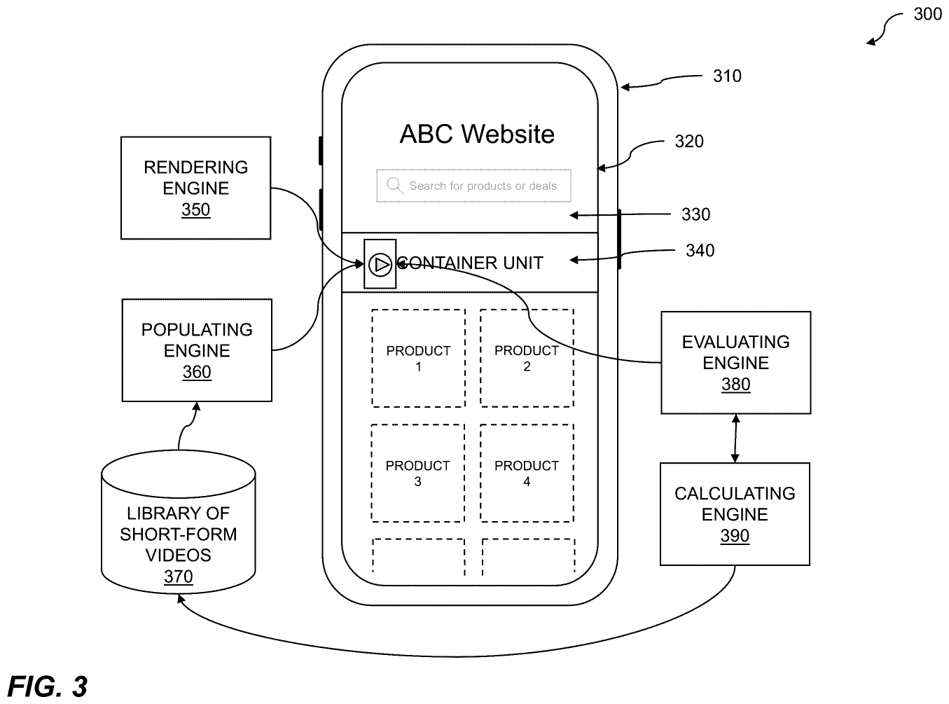

FIG. 3 is an infographic for temporal analysis to determine short-form video engagement. A search for products for sale, short-form videos, or related topics is initiated by a user on a webpage. The search request is captured by one or more processors and used to select one or more short-form videos from a library. A container unit is inserted into the user webpage and populated with one or more of the selected short-form videos. As the videos are viewed by the user, interactions are initiated with the user to determine an engagement metric to quantify the level of interest in the videos. The engagement metric calculations are dynamic, being measured at several different points of time as the video viewing progresses. In some embodiments, the list of short-form videos is reordered to reflect greater or lesser engagement metrics, so that the highest scoring video appears first in the list. In some embodiments, short-form videos that receive a calculated engagement score that falls below a predetermined threshold value are removed from the container unit and replaced with videos with a higher engagement metric.

The infographic 300 includes a computing device 310 capable of displaying webpages. The device can be a mobile phone, tablet, laptop, or desktop computer. In FIG. 3, the ABC Website is displayed 320 as a typical webpage capable of generating a search for products and services. The webpage 330 can be overlaid to allow additional elements such as a container unit 340 to appear within the device display 320 without requiring a refresh cycle. The container unit can be populated with one or more short-form videos selected from a library of videos. In embodiments, the container unit can be configured to display the short-form videos in different arrangements, such as carousel frames, story block frames, grid frames, or floating video players. A carousel frame widget inserts a set of related containers within a primary container, each populated by a single related short-form video. A carousel frame widget allows multiple selected videos to be placed on the website simultaneously. Story blocks are stock-published video footage, templates, music, and photo content available for download from vendors. A story block frame widget populates a container with one or more story block videos from a particular vendor. A grid frame widget allows elements to be placed in specific locations within the container using standardized row and column references. Header information, color schemes, company logos, etc., can thus be placed into the container unit in specific locations along with the selected short-form videos. A floating video player widget is a video player program that runs entirely within the container unit without affecting the displayed main webpage. The container unit “floats” on top of the originating website page so that no format or content disruption occurs.

The infographic 300 can include a rendering engine 350 and a populating engine 360. In embodiments, the populating engine 360 can place one or more short-form videos selected from a library of short-form videos 370 into a container unit 340 inserted into a webpage 330. The rendering engine 350 can insert one or more user interaction processes into the container unit at the same time, allowing the user to respond to polls, questions, and texts while the short-form videos are playing. As the user responds to the various interaction methods, an evaluating engine 380 can capture the user responses and pass them to a calculating engine 390 to generate an engagement metric. The engagement metric is a numeric representation of the level of interest a user has in a particular short-form video. In some embodiments, the metric can be determined using stochastic analysis in order to allow for a certain level of randomness in the data set. The engagement metric can be recalculated at several different points in the viewing of the short-form videos, requiring temporal analysis methods to be used to study the degree of change in engagement of a user over time.

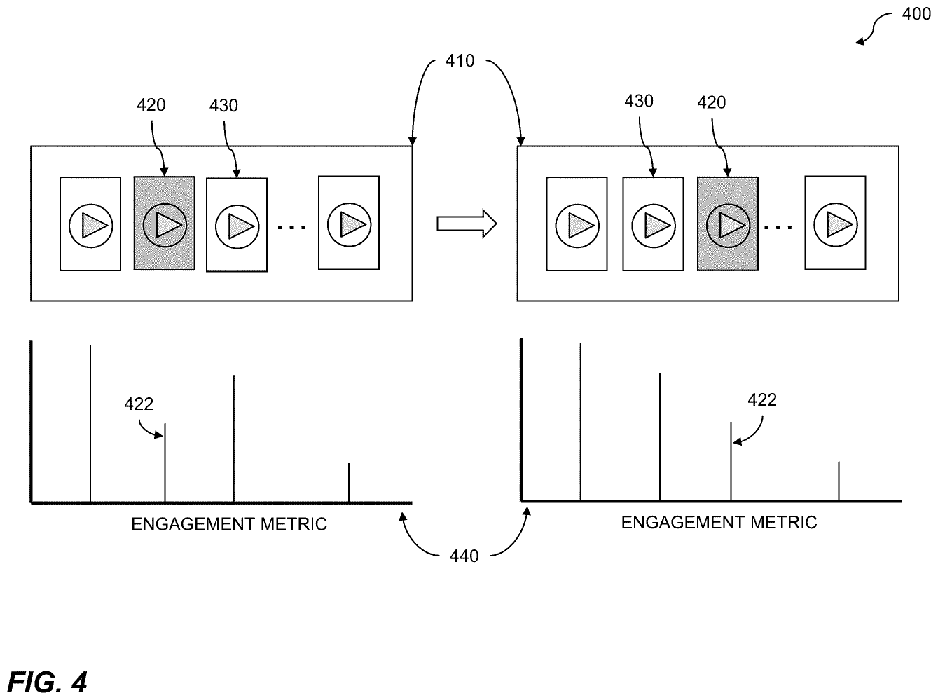

FIG. 4 is an infographic for moving a short-form video based on an engagement metric. A search for products for sale, short-form videos, or related topics is initiated by a user on a webpage. The search request is captured by one or more processors and used to select one or more short-form videos from a library. A container unit is inserted into the user webpage and populated with one or more of the selected short-form videos. As the videos are viewed by the user, interactions are initiated with the user to determine an engagement metric to quantify the level of interest in the videos. The engagement metric calculations are dynamic, being measured at several different points of time as the video viewing progresses. In some embodiments, the list of short-form videos is reordered to reflect greater or lesser engagement metrics, so that the highest scoring video appears first in the list. The reordered short-form videos can be reevaluated by the user and an updated engagement score can be calculated and recorded to the metadata of the short-form video.

The infographic 400 includes a group of short-form videos selected from a library of videos. The short-form videos 420 and 430 are selected based on search criteria from a user webpage. In embodiments, a container unit can be inserted into the user webpage as the short-form videos are selected. The container unit can be configured to display the short-form videos in different arrangements, such as carousel frames, story block frames, grid frames, or floating video players. A carousel frame widget inserts a set of related containers within a primary container, each populated by a single related short-form video. A carousel frame widget allows multiple selected videos to be placed on the website simultaneously. Story blocks are stock-published video footage, templates, music, and photo content available for download from vendors. A story block frame widget populates a container with one or more story block videos from a particular vendor. A grid frame widget allows elements to be placed in specific locations within the container using standardized row and column references. Header information, color schemes, company logos, etc., can thus be placed into the container unit in specific locations along with the selected short-form videos. A floating video player widget is a video player program that runs entirely within the container unit without affecting the displayed main webpage. The container unit “floats” on top of the originating website page so that no format or content disruption occurs. The container unit 410 can be populated with the selected short-form videos 420 and 430, using one of the arrangements described above.

The infographic 400 can include an engagement metric 440 for each of the short-form videos populating the container unit 410. In embodiments, the engagement metric is calculated as the user responds to polls, questions, and texts rendered on the device which includes the container unit. The calculation of the engagement metric for each short-form video is accomplished as the user views the video and responds to the rendered interaction queries. In FIG. 4, the engagement metric 422 is calculated for short-form video 420. The engagement metrics for all of the short-form videos in the container unit 410 are stored and can be sorted as well as compared to one another and a threshold value. After an engagement metric has been calculated for all of the short-form videos, the videos can be sorted based on the engagement metric, so that the short-form video with the highest metric score takes the first position in the container unit, followed by the short-form video with the second highest score, etc. In FIG. 4, short-form video 420 has an engagement score of 422. The engagement score of short-form video 430 is higher, as can be seen in the left-side set of engagement metrics 440. After sorting the short-form videos using the engagement metrics, video 430 takes the position in the container unit previously held by video 420, since the engagement score for video 430 is higher than that of video 420. After the videos are sorted and reordered in the container unit, the user can continue to interact with the complete set of short-form videos, resulting in updated engagement scores and subsequent reordering.

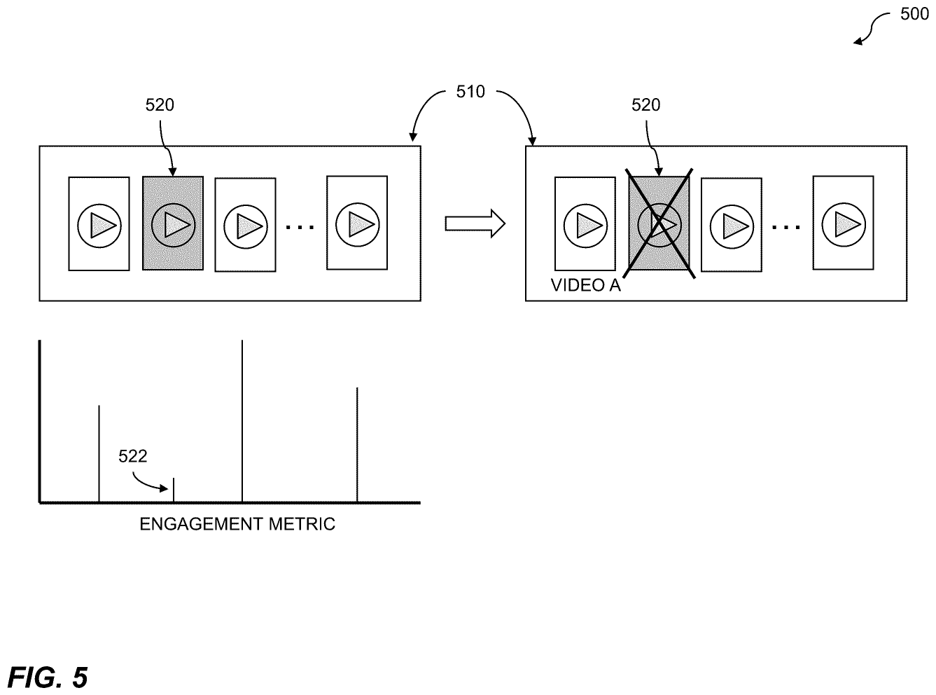

FIG. 5 is an infographic for removing a short-form video based on an engagement metric. A search for products for sale, short-form videos, or related topics is initiated by a user on a webpage. The search request is captured by one or more processors and used to select one or more short-form videos from a library. A container unit is inserted into the user webpage and populated with one or more of the selected short-form videos. As the videos are viewed by the user, interactions are initiated with the user to determine an engagement metric to quantify the level of interest in the videos. The engagement metric calculations are dynamic, being measured at several different points of time as the video viewing progresses. In some embodiments, a threshold engagement metric value can be used to retain or remove videos from the list of short-form videos based on a comparison to the threshold value. In some embodiments, a removed short-form video can be replaced with another video from the short-form video library and then populated to the webpage container unit. The inserted short-form video can be evaluated by the user and an engagement score can be calculated and recorded to the metadata of the short-form video.

The infographic 500 can include a container unit 510 that can be inserted into a user webpage as short-form videos are selected from a video library. The container unit can be configured to display the short-form videos in different arrangements, such as carousel frames, story block frames, grid frames, or floating video players. A carousel frame widget inserts a set of related containers within a primary container, each populated by a single related short-form video. A carousel frame widget allows multiple selected videos to be placed on the website simultaneously. Story blocks are stock-published video footage, templates, music, and photo content available for download from vendors. A story block frame widget populates a container with one or more story block videos from a particular vendor. A grid frame widget allows elements to be placed in specific locations within the container using standardized row and column references. Header information, color schemes, company logos, etc., can thus be placed into the container unit in specific locations along with the selected short-form videos. A floating video player widget is a video player program that runs entirely within the container unit without affecting the displayed main webpage. The container unit “floats” on top of the originating website page so that no format or content disruption occurs. The container unit 510 can be populated with the selected short-form videos including 520, based on search criteria from a user webpage, using one of the arrangements described above.

The infographic 500 can include an engagement metric 522 for the short-form video 520 populating the container unit 510. In embodiments, the engagement metric is calculated as the user responds to polls, questions, and texts rendered on the device which includes the container unit. The calculation of the engagement metric for each short-form video is accomplished as the user views the video and responds to the rendered interaction queries. In FIG. 5, the engagement metric 522 is calculated for short-form video 520. The engagement metrics for all of the short-form videos in the container unit can be stored and sorted as well as compared to one another and a threshold value. After an engagement metric has been calculated for all of the short-form videos, the videos can be compared to a predetermined threshold value. In some embodiments, a short-form video with a calculated engagement score that falls below the threshold value can be removed from the container unit. In FIG. 5, short-form video 520 has an engagement score 522. In this example, the engagement metric falls below the threshold set for the videos. The right side of the figure shows short-form video 520 being removed from the container unit. After removal, another short-form video from the video library that satisfies the search criteria from the user webpage can be inserted into the container unit. After the video is inserted, the user can continue to interact with the complete set of short-form videos, resulting in updated engagement scores and subsequent reordering.

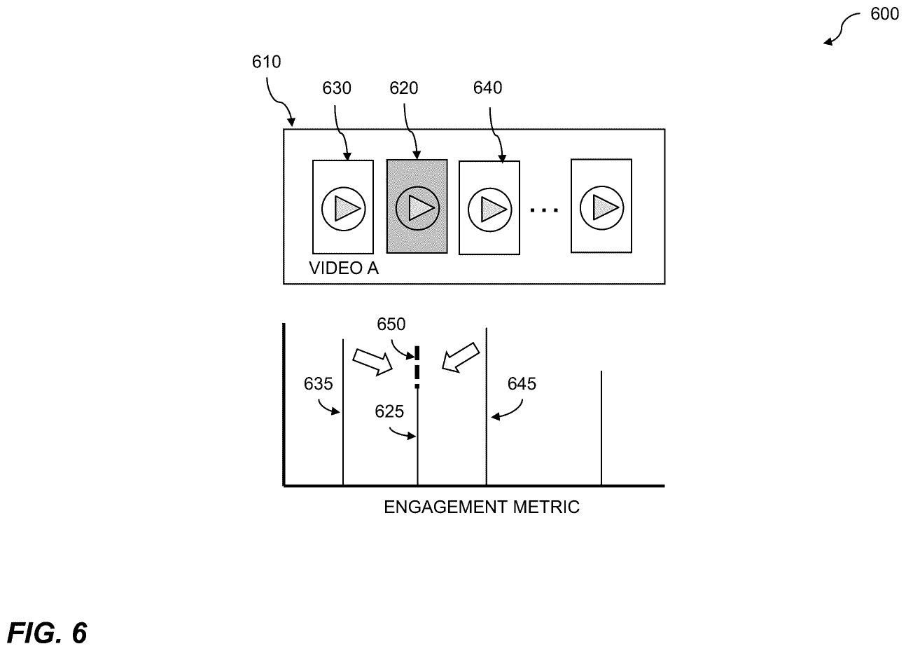

FIG. 6 is an infographic for boosting an engagement metric. A search for products for sale, short-form videos, or related topics can be initiated by a user on a webpage. The search request can be captured by one or more processors and used to select one or more short-form videos from a library. A container unit can be inserted into the user webpage and populated with one or more of the selected short-form videos. As the videos are viewed by the user, interactions can be initiated with the user to determine an engagement metric to quantify the level of interest in the videos. The engagement metric calculations are dynamic, being measured and updated at several different points of time as the video viewing progresses. In some embodiments, the engagement metric for a short-form video can be boosted, using the scores of other short-form videos selected for the same container unit to create a normalized engagement metric. The boosted engagement metric can be calculated and recorded to the metadata of the short-form video. The short-form video can then be re-evaluated by the webpage user. In embodiments, the opportunity to boost a short-form video score can be auctioned to advertisers or vendors.

The infographic 600 can include a container unit 610 populated with short-form videos 620, 630, 640 selected from a library of short-form videos. In embodiments, the container unit 610 can be populated based on search criteria from a user webpage. In some embodiments, the container unit 610 can be configured to display the short-form videos in different arrangements, such as carousel frames, story block frames, grid frames, or floating video players. A carousel frame widget inserts a set of related containers within a primary container, each populated by a single related short-form video. A carousel frame widget allows multiple selected videos to be placed on the website simultaneously. Story blocks are stock-published video footage, templates, music, and photo content available for download from vendors. A story block frame widget populates a container with one or more story block videos from a particular vendor. A grid frame widget allows elements to be placed in specific locations within the container using standardized row and column references. Header information, color schemes, company logos, etc., can thus be placed into the container unit in specific locations along with the selected short-form videos. A floating video player widget is a video player program that runs entirely within the container unit without affecting the displayed main webpage. The container unit “floats” on top of the originating website page so that no format or content disruption occurs. In embodiments, a webpage user can view each of the short-form videos 620, 630, 640 and interact with them to generate an engagement metric 625, 635, 645 for each video. The engagement metric can be calculated based on user interactions including polls, questions, and text messages rendered to the container unit as the user views the short-form videos. As each short-form video is viewed and an engagement metric 625, 635, 645 is calculated, the engagement metric can be recorded to the metadata of the short-form videos 620, 630, 640.

In some embodiments, the engagement metric of a particular short-form video 620 can be boosted using the engagement scores of other short-form videos 630, 640 in the same container unit 610. In FIG. 6, the engagement metric 625 of short-form video 620 is lower than the engagement metrics 635 and 645 of the short-form videos 630, 640 that appear on either side of video 620 in container unit 610. To boost the engagement metric of short-form video 620, the difference between engagement metric 635 and 625 and the difference between engagement metric 645 and 625 can be determined and both differences can be added to the engagement metric 625, resulting in a normalized or boosted engagement metric 650 for short-form video 620. The same mathematical result can be obtained by adding the engagement metric 635 to the engagement metric 645 and then subtracting the engagement metric 625. The boosted engagement metric 650 can be recorded to the metadata of the short-form video 620. After the short-form video engagement metric is boosted, the user can continue to interact with the complete set of short-form videos, resulting in updated engagement scores and subsequent reordering.

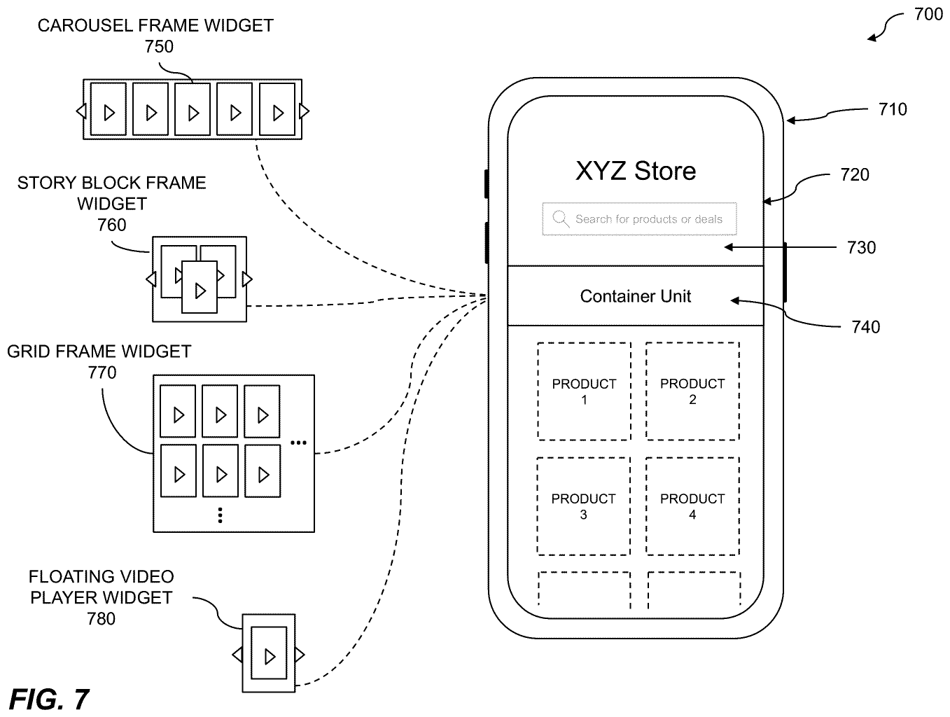

FIG. 7 shows populating of a container unit. In embodiments, a search for products for sale, short-form videos, or related topics can be initiated by a user on a webpage. The search request can be captured by one or more processors and can be used to select one or more short-form videos from a library. A container unit can be inserted into the user webpage and populated with one or more of the selected short-form videos. In some embodiments, the container unit can be configured in different ways to present the short-form videos to the user. The size and resolution options of the display being used, user preferences, applications available on the user device, and other factors can contribute to the selection of the container unit configuration to be used.

The infographic 700 shows a device 710 capable of displaying an Internet browser webpage 720. In embodiments, the webpage can be used to initiate a search 730 for products, short-form videos, or related information. The search can be captured by one or more processors and used to select short-form videos that satisfy the user search criteria. As the short-form videos are selected, a container unit 740 can be inserted into the user webpage 720 that initiated the search. In some embodiments, the container unit 740 can be arranged in different ways depending on the frame or player widget selected for use. A widget is an application or a component of an interface to an application, which enables a user to perform a function or access a service. In FIG. 7, the widgets can be used to populate a container unit 740 with short-form videos selected from a library of short-form videos. The widgets can allow a user to select videos within the container unit 740 to be played or bypassed in favor of other short-form videos appearing in the container unit. The widgets can also be used to display text information, such as questions or polls, so that the user can interact with the video and respond to the questions or polls at the same time. The responses can be used to evaluate user engagement with the videos and calculate an engagement metric to be used along with the video itself. In some embodiments, the container unit 740 can be configured to display the short-form videos in a carousel arrangement using a carousel frame widget 750. A carousel frame widget 750 inserts a set of related containers within a primary container, each populated by a single related short-form video in a left-to-right rotating arrangement. A carousel frame widget 750 allows multiple selected videos to be placed on the website simultaneously. In some embodiments, a slider with arrows that appear at the side of each video can be included. A simple selection bar or thumbnails of the short-form videos can appear underneath the primary viewing frame so that the user can move from one video to the next as desired. Timers can be built into the widget so that total viewing time, time elapsed, order of videos selected, etc. can be recorded and used as part of the engagement calculation. In some embodiments, a story block frame widget 760 can be used to display short-form videos selected from a library of short-form videos. Story blocks are stock-published video footage, templates, music, and photo content available for download from vendors. A story block frame widget 760 populates a container with one or more story block videos from a particular vendor. The short-form videos can overlay one another, with the first video appearing on top. The order in which the videos appear within the story block frame can be used to communicate a story or message to the user in a particular order. In some embodiments, the user can select which video in the sequence to be viewed. The user can skip ahead, step back, or stop the story at any point. In some embodiments, short-form videos from the library of short-form videos can be added to the set of story block videos from a vendor. As the engagement metrics for the short-form videos are calculated and used to re-sort, replace, or remove videos within the story block frame 760, the story or message being communicated by the videos can be shaped or refined by the user. Timers can be built into the widget so that total viewing time, time elapsed, order of videos selected, etc. can be recorded and used as part of the engagement calculation. In some embodiments, a grid frame widget 770 can be used to configure the container unit 740. A grid frame widget allows elements, including short-form videos, to be placed in specific locations within the container using standardized row and column references. Header information, color schemes, company logos, etc., can thus be placed into the container unit in specific locations, along with the selected short-form videos. In some embodiments, the short-form video with the highest engagement score can appear in the upper left corner, followed by the second highest engagement score video appearing on the same row immediately to the right of the first video, and so on. Depending on the size of the display being used and the number of short-form videos selected, the user can simultaneously view several rows and columns of videos in thumbnail size. This arrangement allows the user to select videos to view in any order desired, giving the engagement metric calculation opportunity for additional refinement as the short-form videos are compared head to head. As with the other container unit widgets, timers can be built into the widget so that total viewing time, time elapsed, order of videos selected, etc. can be recorded and used as part of the engagement calculation. In some embodiments, a floating video player widget 780 can be used to display the videos selected from a short-form video library. A floating video player widget 780 is a video player program that runs entirely within the container unit 740 without affecting the displayed main webpage. The container unit “floats” on top of the originating website page so that no format or content disruption occurs. In embodiments, one short-form video at a time is visible in the floating video player 780 frame. The advantage to the user is that the container unit frame can be placed anywhere on the display of the device, allowing the user flexibility as to when to view the short-form videos in relation to other elements appearing in the display. In some embodiments, movement of the floating video player on the display can contribute to the engagement metric. As with the other container unit widgets, timers can be built into the widget so that total viewing time, time elapsed, order of videos selected, etc. can be recorded and used as part of the engagement calculation.

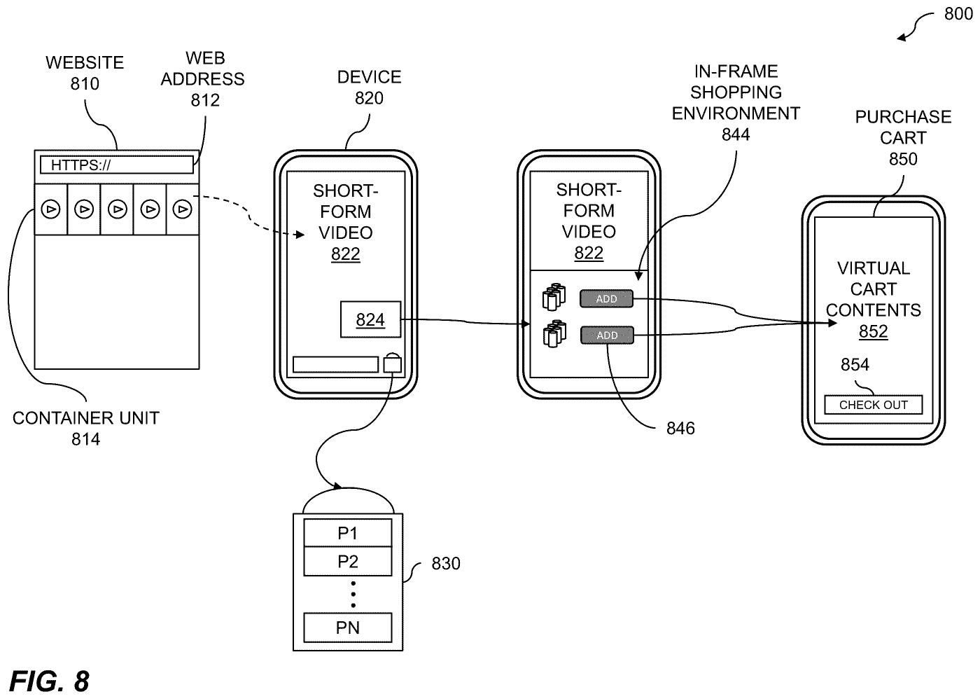

FIG. 8 shows an ecommerce purchase with a container unit. As described above and throughout, a search for products for sale, short-form videos, or related topics can be initiated by a user on a webpage. The search request can be captured by one or more processors and used to select one or more short-form videos from a library. A container unit can be inserted into the user webpage and populated with one or more of the selected short-form videos. As the videos are viewed by the user, interactions can be initiated with the user to determine an engagement metric to quantify the level of interest in the videos. The engagement metric calculations are dynamic, being measured and updated at several different points of time as the video viewing progresses. In some embodiments, an ecommerce purchase of a product or service highlighted by one or more of the short-form videos used to populate the container unit can be enabled. The container unit can include an in-frame shopping environment with a virtual purchase cart and promotional information selected by a vendor or advertiser of products for sale. The virtual purchase cart can be displayed alongside or partially covering the short-form videos as they play within the container unit. At some point during the viewing of short-form videos, the user can display all items selected for purchase and check out to complete the sale cycle.

The infographic 800 can include a website 810 as part of an Internet browser session displayed on a computing device 820. In embodiments, the device 820 can be a mobile phone, tablet, laptop computer or desktop computer. The website can be displayed normally within the browser session, including the web address 812 shown at the top of the web page. As described above and throughout, as short-form videos are selected based on a search generated by the user, a container unit 814 can be inserted into the website page 810 on the user device 820. The container unit 814 can be populated by the short-form videos 822 selected by the user search. As the short-form video 822 is viewed by the user, an in-frame purchase cart 824 can be inserted into the container unit. The purchase cart 824 can be linked to a library of products for sale 830 that are related to the short-form videos being viewed by the user. As the short-form video 822 plays, the in-frame purchase cart 824 can be expanded in the container unit 814 to show an in-frame shopping environment 844. The in-frame shopping environment 844 can include a list of products for sale and the option to add 846 one or more of the products to be purchased. As short-form videos 822 continue to be viewed by the user, additional products for sale can be viewed and selected for purchase by the user within the in-frame shopping environment 844. At a time of the user's choosing, the purchase cart 850 can be expanded to display all of the products selected for purchase 852 during the short-form video viewing. In some embodiments, promotions for one or more of the products for sale can be displayed to the user. The promotions can be selected by vendors or advertisers based on the shopping history of the user or bids submitted by advertisers or vendors of the products for sale. In some embodiments, the expanded purchase cart can give the user the option to increase or decrease the number of each item to be purchased or remove certain items from the list. After all adjustments have been made, the user can check out 854 and finalize payment for all selected products for sale.

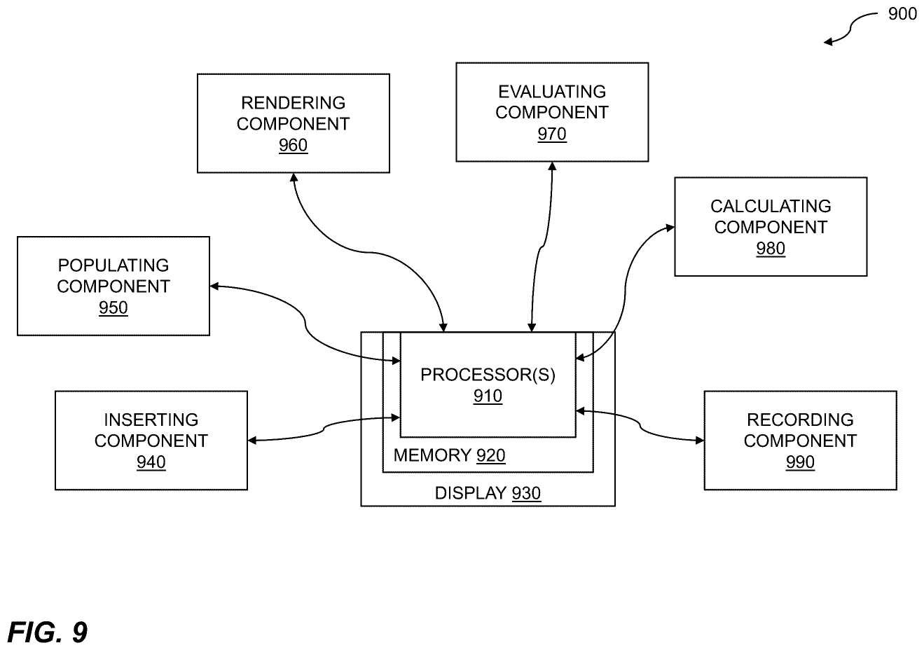

FIG. 9 is a system diagram for stochastic data to determine short-form video engagement. The system 900 can include one or more processors 910 coupled to a memory 920, which stores instructions. The system 900 can include a display 930 coupled to the one or more processors 910 for displaying data, video streams, videos, video metadata, product information, auction bid information, editing information, system logs, webpages, intermediate steps, instructions, and so on. In embodiments, one or more processors 910 are coupled to the memory 920 where the one or more processors, when executing the instructions which are stored, are configured to: insert a container unit into a webpage; populate the container unit with one or more short-form videos from a short-form video library; render a short-form video from within the one or more short-form videos to a user, wherein user interactions are associated with the short-form video; evaluate the user interactions, using one or more processors, wherein the evaluating occurs as the video is rendered to the user; calculate an engagement metric, wherein a first rate of change in the user interactions during a first time period is compared to a second rate of change in the user interactions over a second time period; and record the engagement metric, wherein the engagement metric is associated with the short-form video.

The system 900 can include an inserting component 940. The inserting component 940 can include functions and instructions for inserting a container unit into the website that sent the short-form video request. In embodiments, the container unit comprises a story block, carousel, floating player, or grid. Story blocks are stock published video footage, templates, music, and photo content available for download from vendors. A carousel is a set of related containers within a primary container unit, with each related container populated by a single selected short-form video. A floating player is a video player that runs entirely within the container unit without affecting the displayed main webpage. A grid container allows elements to be placed in specific locations within the container using standardized row and column references. In some embodiments, the inserting component can insert polls to be taken by the user, questions to be answered by the user, or texts to be viewed by the user as the short-form videos are being watched. The responses to the inserted interaction queries can be captured and used as part of the calculation of an engagement metric. In some embodiments, the inserting component can be used to insert a virtual purchase cart into a container unit as part of an ecommerce purchase of one or more products for sale. The virtual purchase cart can be displayed in the container unit while the short-form video plays for the user. The purchase cart can cover a portion of the short-form video as it plays for the user. The purchase of items for sale, highlighted by the short-form videos being viewed, can be completed as the user watches the short-form videos.

The system 900 can include a populating component 950. The populating component 950 can include functions and instructions for populating one or more related short-form videos into the container unit on a website. In some embodiments, the populating component 950 can include organic, sponsored, livestream, replayed livestream, or promotional short-form videos. Organic videos are made and shared using the free, built-in capabilities of a particular social media platform. Every social media platform has capabilities available to any user: posts, hashtags, likes, shares, etc. Videos shared with these built-in capabilities are part of the natural uses of the platform itself. Sponsored videos are paid for and directly associated with a particular organization, group, or individual. Livestream events are broadcast over the Internet for live viewing. These events are typically recorded for replaying as stand-alone videos in complete or edited form. Promoted videos are presented to viewers by third parties, celebrities, social media influencers, advertisers, product manufacturers, etc. They can be recommended to viewers as part of other forms of advertising or within other forms of media. In some embodiments, metadata can be associated with short-form videos populating the container unit. The metadata can include creation date, geographic location, title, subject, host individual information, video resolution, video format, language, or other relevant information. In some embodiments, values from the metadata can be used as part of the calculating of the engagement metric. The metadata can be used to store an engagement metric calculated as part of the viewing and interaction with the short-form videos. As the engagement metric is calculated for each of the short-form videos viewed by the user, the populating component 950 can populate the container unit based on the engagement metric that was recorded with the one or more short-form videos. In some embodiments, the recorded engagement metric can be attached to the short-form video as part of an earlier, separate viewing and evaluating session completed by different users. In some embodiments, the engagement metric attached to the short-form video can be used with the populating component 950 to change the order of the one or more short-form videos in the container unit, wherein the order is based on the engagement metric of a neighboring short-form video, or on a recalculated engagement metric of the one or more short-form videos. The order can be changed to display the short-form video with the highest engagement metric first, followed by the next highest engagement metric, and so on. In some embodiments, the populating component 950 can be used to include different short-form videos into the container unit based on a threshold engagement metric value. The threshold value can be used to remove or retain short-form videos in the container unit based on a comparison of the engagement metric scores.

The system 900 can include a rendering component 960. The rendering component 960 can include functions and instructions for rendering a short-form video from within the one or more short-form videos to a user, wherein user interactions are associated with the short-form videos. In embodiments, the user interactions can include polls taken by the user while viewing the short-form video, questions answered by the user while viewing the short-form video, text responses by the user while viewing the short-form video. In some embodiments, a purchase history by the user and video consumption behavior data from third-party sources can be included as part of the user interaction data collected. All of the user interaction data can be used as part of the calculation of an engagement metric detailed in later steps of the system 900 diagram. In embodiments, the rendering can include a second short-form video. In some embodiments, the rendering can include additional short-form videos, depending on the number of videos selected from the short-form video library and meeting the search criteria submitted as part of the user webpage search.

The system 900 can include an evaluating component 970. The evaluating component 970 can include functions and instructions for the user interactions, using one or more processors 910, wherein the evaluating occurs as the video is rendered to the user. In embodiments, metadata associated with the short-form videos is evaluated as part of the engagement metric calculating process. The short-form video metadata can include hashtags, repost velocity, user attributes, user history, ranking, product purchase history, user history, or user actions. In embodiments, the evaluating component 970 can be used to capture user interaction responses from polls, questions, or texts displayed while the user is viewing the short-form videos. The data collected by the evaluating component 970 can be sent to the calculating component 980 in order to generate and refine the engagement metric for each short-form video.

The system 900 can include a calculating component 980. In embodiments, the calculating component 980 can include functions and instructions for calculating an engagement metric, wherein a first rate of change in the user interactions during a first time period is compared to a second rate of change in the user interactions over a second time period. The change in content engagement with the short-form video between the first and second time periods can be used to determine an increase or decrease in engagement and used to generate a metric for the short-form video content. For example, as a user begins to watch a short-form video and respond to related questions that appear on the screen, the response time to questions during the first 20 seconds of the video may be short, indicating high interest and engagement with the video. After 45 seconds, the response time to questions may increase, indicating a loss of interest. After 60 seconds, user responses may cease altogether. The resulting engagement metric for such an example would be lower than for a video that elicited short response times to questions throughout the duration of the video. As the user views a short-form video, user interest in the video can be determined, based on a view history by the user, wherein the view history includes a total watch time. In some embodiments, the total watch time can include view history from a plurality of users. In embodiments, metadata associated with the short-form videos can be evaluated as part of the engagement metric calculating process. The short-form video metadata can include hashtags, repost velocity, user attributes, user history, ranking, product purchase history, user history, or user actions. The engagement metric can be comprised of a combined score based on the metadata and user interactions gathered from the rendering component 960 and evaluating component 970. In some embodiments, a second engagement metric can be calculated using the calculating component 980, wherein a first rate of change of the metadata during a third time period is compared to a second rate of change in the metadata over a fourth time period. The second engagement metric can be recorded with the short-form video, replacing, or being included with the first engagement metric. As the short-form videos continue to be viewed by the user, multiple versions of the engagement metric can be calculated and recorded. In some embodiments, user interaction data can be combined with metadata values to create new combined engagement metric scores. Each iteration of the engagement score can be recorded to the metadata of the short-form videos. In some embodiments, the calculating component 980 can be used to boost the engagement metric of a particular short-form video based on the engagement metrics of the surrounding videos in the container unit. The opportunity to boost the engagement metric can be auctioned to advertisers so that their short-form videos receive more views and avoid being dropped from subsequent video searches. For example, if the second short-form video in a container has an engagement metric of 6, the third short-form video has an engagement metric of 4, and the fourth short-form video has an engagement metric of 7, an advertiser linked to the third short-form video could bid to have its engagement metric boosted. One method of boosting the engagement metric would be to calculate a normalized metric by adding the values of the second and fourth short-form videos together and then subtracting the original engagement metric (6+7−4=9). The boosted engagement metric value 9 would then be recorded into the metadata of the third video and the order of the videos in the container can be changed to reflect the boosted metric.

The system 900 can include a recording component 990. The recording component 990 can include functions and instructions for recording metadata values and engagement metric scores to one or more short-form videos. As the calculating component 980 calculates engagement metric scores, the recording component 990 can record the metric scores to the short-form videos. Multiple versions of the engagement metric scores can be calculated and recorded for each short-form video that is placed in the container unit by the populating component 950. In some embodiments, some short-form videos can be removed from the container unit, if the most recent version of the engagement metric falls below a threshold value established for the container unit. In this case, another short-form video can be selected from the short-form video library and presented to the user for evaluation. After calculating an engagement metric for the new short-form video, the recording component can be used to store the engagement metric to the metadata of the short-form video.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams, infographics, and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions-generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for evaluating videos comprising:
inserting a container unit into a webpage;
populating the container unit with one or more short-form videos from a short-form video library;
rendering a short-form video from within the one or more short-form videos to a user, wherein user interactions are associated with the short-form video;
evaluating the user interactions, using one or more processors, wherein the evaluating occurs as the short-form video is rendered to the user;
calculating an engagement metric, wherein a first rate of change in the user interactions during a first time period is compared to a second rate of change in the user interactions over a second time period; and
recording the engagement metric, wherein the engagement metric is associated with the short-form video.

2. The method of claim 1 wherein the populating the container unit is based on the engagement metric that was recorded with the one or more short-form videos.

3. The method of claim 1 further comprising changing an order of the one or more short-form videos in the container unit based on the engagement metric recorded with the one or more short-form videos.

4. The method of claim 1 further comprising comparing the engagement metric to a threshold value.

5. The method of claim 4 further comprising removing a populated short-form video from within the one or more short-form videos that were populated in the container unit, wherein the engagement metric is less than the threshold value.

6. The method of claim 5 further comprising replacing the populated short-form video that was removed with a second short-form video from the short-form video library, wherein the replacing is based on the engagement metric recorded with the second short-form video.

7. The method of claim 1 further comprising boosting the engagement metric of the short-form video.

8. The method of claim 7 wherein the boosting is based on the engagement metric of a neighboring short-form video within the container unit.

9. The method of claim 1 further comprising evaluating metadata associated with the short-form video.

10. The method of claim 9 further comprising calculating a second engagement metric, wherein a first rate of change of the metadata during a third time period is compared to a second rate of change in the metadata over a fourth time period.

11. The method of claim 10 wherein the metadata includes hashtags, repost velocity, user attributes, user history, ranking, product purchase history, view history, or user actions.

12. The method of claim 10 wherein the populating the container unit is based on the second engagement metric.

13. The method of claim 9 further comprising determining a combined metric based on combining the metadata and the user interactions.

14. The method of claim 13 wherein the combined metric is based on a first rate of change of the combined metric over a fifth time period compared to a second rate of change of the combined metric over a sixth time period.

15. The method of claim 14 wherein the populating the container unit is based on the combined metric.

16. The method of claim 1 further comprising determining user interest, based on a view history by the user, wherein the view history includes a total watch time.

17. The method of claim 16 wherein the user interest is based on a first rate of change of the view history over a seventh time period compared to a second rate of change in the view history over an eighth time period.

18. The method of claim 17 wherein the populating the container unit is based on user interest.

19. The method of claim 1 further comprising enabling an ecommerce purchase of a product for sale to the user within the short-form video that was rendered, wherein the product for sale is relevant to the short-form video.

20. The method of claim 19 wherein the ecommerce purchase is accomplished within the short-form video.

21. The method of claim 19 wherein the enabling an ecommerce purchase includes a virtual purchase cart.

22. The method of claim 1 further comprising presenting a promotion, to the user, in the short-form video.

23. The method of claim 22 wherein the presenting is based on a bid from an advertiser and/or the engagement metric of the short-form video.

24. The method of claim 1 wherein the populating the container unit is based on a bid from an advertiser.

25. A computer program product embodied in a non-transitory computer readable medium for evaluating videos, the computer program product comprising code which causes one or more processors to perform operations of:
inserting a container unit into a webpage;
populating the container unit with one or more short-form videos from a short-form video library;
rendering a short-form video from within the one or more short-form videos to a user, wherein user interactions are associated with the short-form video;
evaluating the user interactions wherein the evaluating occurs as the short-form video is rendered to the user;
calculating an engagement metric, wherein a first rate of change in the user interactions during a first time period is compared to a second rate of change in the user interactions over a second time period; and
recording the engagement metric, wherein the engagement metric is associated with the short-form video.

26. A computer system for evaluating videos comprising:
a memory which stores instructions;
one or more processors coupled to the memory wherein the one or more processors, when executing the instructions which are stored, are configured to:
insert a container unit into a webpage;
populate the container unit with one or more short-form videos from a short-form video library;
render a short-form video from within the one or more short-form videos to a user, wherein user interactions are associated with the short-form video;
evaluate the user interactions wherein the evaluating occurs as the short-form video is rendered to the user;
calculate an engagement metric, wherein a first rate of change in the user interactions during a first time period is compared to a second rate of change in the user interactions over a second time period; and
record the engagement metric, wherein the engagement metric is associated with the short-form video.
